(19) United States
(12) Patent Application Publication
(10) Pub. No.: US 2002/0050025 A1
(43) Pub. Date: May 2, 2002

(54) Hinge for pieces of furniture with device for the slowed closing of the door

(75) Inventor: Luciano Salice, Carimate (IT)

Correspondence Address: THE FIRM OF KARL F ROSS, 5676 RIVERDALE AVENUE, PO BOX 900, RIVERDALE (BRONX), NY, 10471-0900, US

(73) Assignee: ARTURO SALICE S.P.A.

(21) Appl. No.: 09/902,499

(22) Filed: Jul. 10, 2001

(30) Foreign Application Priority Data
Oct. 10, 2000 (IT) MI2000U000565

(51) Int. Cl. E05D 7/10

(52) U.S. Cl. 16/254

(57) ABSTRACT

The present invention relates to a hinge, in particular for pieces of furniture, with an arm fixable to the body of the piece of furniture, connected to a portion of hinge that oscillates through two equalizers housed on transversal pins, of which—in the portion of one of its oscillation axes—one equalizer exhibits a projecting part forming a lever arm, and with an elastic member that stresses the projecting part of the equalizer so as to cause a thrust in the closing direction on the oscillating hinge portion.

In order to obtain the slowed closing of the door, one of the equalizers is provided with a second projecting part on which a second elastic member acts so as to exert a thrust that, for an oscillation portion close to the closed position of the oscillating hinge portion contrasts the thrust exerted by the first elastic member.

### DESCRIPTION

The present invention relates to a hinge, in particular for pieces of furniture, with an arm fixable to the body of the piece of furniture, connected to a portion of hinge that oscillates through two equalisers housed on transversal pins, of which—in the portion of one of its oscillation axes—one equaliser exhibits a projecting part forming a lever arm, and with an elastic member that stresses the projecting part of the equaliser so as to cause a thrust in the closing direction on the oscillating hinge portion.

Closing devices applied to hinges for pieces of furniture are known, to which there are coupled deceleration systems for decreasing the door speed just before its closed position, so as to prevent irritating noise and shocks.

DE 31 20 201 A1 discloses a hinge for pieces of furniture of this type, with a piston housed in the hinge arm, on which there slides a cylinder pulled by a lever integral with an equaliser and braked by a coating of its walls that increases its friction coefficient. Such known deceleration devices do not usually exhibit a complex and high-precision structure, but they also take much space into the hinge arm, thus making the arrangement of fixing and adjustment elements difficult.

Thus, the object of the invention is that of creating a hinge with a closing device of the type described above, which should exhibit a not very expensive and bulky deceleration system.

According to the invention, such object is achieved by providing one of the equalisers with a second projecting part on which a second elastic member acts to exert a thrust that, for an oscillation portion close to the closed position of the oscillating portion of the hinge contrasts the thrust exerted by its first elastic member.

The use of a second contrast elastic member that directly acts on an essential element of the hinge, as an equaliser is, avoids the need of having to use additional elements connected to such essential elements which should realise the braking effect by interacting between themselves. This brings to the use of less components thus allowing to save space.

The two projecting parts on which the two elastic members respectively act can be suitably arranged on the same equaliser.

In a preferred embodiment, the second projecting part consists of a cam obtained on the U-bent sides of the equaliser that is closer to the body of the piece of furniture, and it comprises a first portion that is concentric to the oscillation axis, which in the hinge closing direction is followed by a portion at increasing distance up to an edge, beyond which the distance rapidly decreases.

Just before the closed position of the hinge, the elastic contrast member abuts against the decreasing distance portion just beyond the farthest edge from the oscillation axis, so as to exert a thrust in the closing direction that adds to the thrust exerted by the first elastic member.

The second elastic contrast member can suitably consist of a torsion spring housed on a transversal pin in the hinge arm, with a fixes shank abutting against the back of the hinge arm and the other shank to the equaliser cam.

A further embodiment provides for the torsion spring to have a symmetrical shape, with the fixed shank consisting of two central shanks connected to one another by slot and with two side shanks that abut against the equaliser cams.

The fixed shank of the elastic member can abut against the lower portion of a screw screwed into the back of the hinge arm, which allows adjusting its pre-compression force and thus, the exerted contrast force.

Embodiments of the invention are shown below with reference to the drawings. In such drawings:

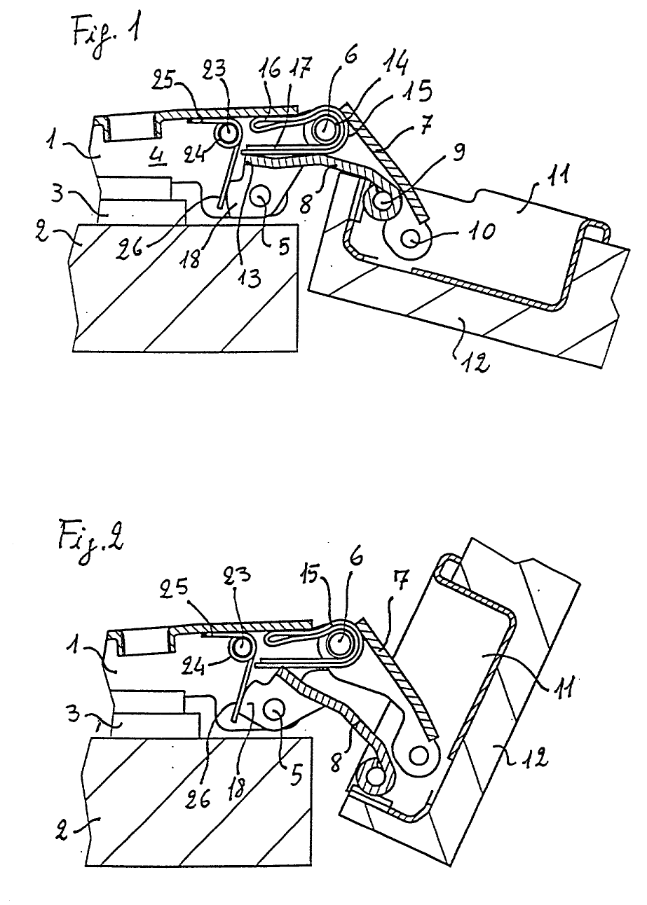

FIG. 1 shows a longitudinal section of a hinge according to the invention in its open position, with arm fixed to the fixed portion of the piece of furniture and mobile portion embedded in a door;

FIG. 2 shows a longitudinal section of the open hinge of FIG. 1 in the position in which the braking effect starts;

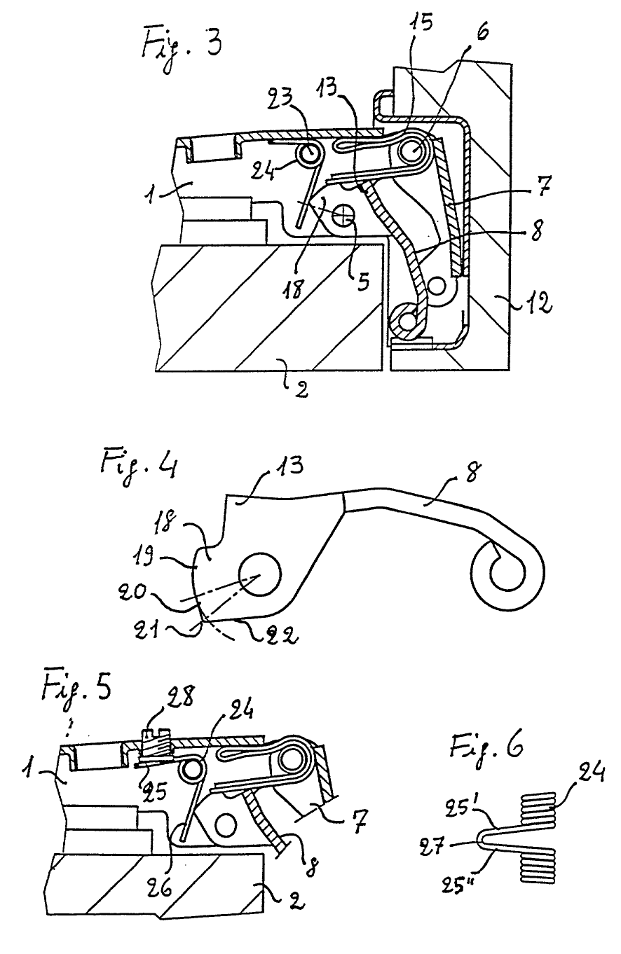

FIG. 3 shows a longitudinal section of the hinge of FIGS. 1 and 2 in its closed position;

FIG. 4 shows an enlarged side view of the equaliser provided with two projecting parts forming lever arms;

FIG. 5 shows a partial longitudinal section corresponding to FIG. 3 of a second embodiment of the hinge; and

FIG. 6 shows a top view of the elastic contrast member.

The U-bent hinge arm 1, of which only the front side is illustrated, is connected in the usual manner to the body of the piece of furniture 2 through a fixing base 3. Pins 5, 6 are held between the sides 4 of the hinge arm 1, on which the first ends of equalisers 7, 8 are housed in an oscillating manner. The other ends of equalisers 7, 8 are housed in an oscillating manner on pins 9, 10, arranged between the walls of the box-shaped oscillating member 11 embedded in a recess of door 12. Equaliser 7 consists of a U-bent plate portion whereas equaliser 8 consists of a lamination curled around pin 9 and U-bent at pin 5. A prolongation forming a projecting part 13 is realised on the back of equaliser 8, in the proximity of the articulation pin 5, so as to make equaliser 8 a two-arm lever.

On the articulation pin 6 between the bent sides of equaliser 7 there is wounded—with the interposition of a plastic bush 14—a lamination spring 15 with two arms 16, 17 of which one (16) abuts against the back of the hinge arm 1 and the other (17), capable of springing, pushes against an edge of the projecting part 13 of equaliser 8 in the manner shown in figures from 1 to 3, thus causing a thrust in the closing direction on the oscillating portion 11 of the hinge.

The hinge exhibits a known construction so far, thus a more detailed description is not provided.

In the portion facing the piece of furniture interior, on the U-bent sides of equaliser 8 that is closer to the body of the piece of furniture 2, there is obtained a second projecting part 18 whose outside edge is exhibits a cam shape. In the portion the is closer to the back of the hinge arm 1, the cam as it can be better seen in FIG. 4—first forms a circumference arc 19 that is concentric to the oscillation pin 5 of equaliser 8, which is followed by a portion 20 whose distance from the axis of pin 5 constantly increases, preferably according to a straight line, up to an edge 21 beyond which the distance rapidly decreases according to a straight line 22.

Between the sides of the hinge arm 1, in the portion above the projecting part 18 of equaliser 8, there is fixed a transversal pin 23 on which a torsion spring 24 is housed, which is the second elastic contrast member. A shank 25 of spring 24 is fixed and abuts against the back of the hinge arm 1, whereas the other shank 26 abuts against the cam-shaped projecting part 18 of equaliser 8.

The torsion spring 24 can have a symmetrical shape, as shown in FIG. 6, where the fixed shank 25 consists of two central shanks 25′, 25″, connected to one another by a slot 27, and arms 26—that abut against the cams of the U-bent equaliser 8—are obtained at both sides.

In the open position of the hinge, that can be seen in FIG. 1, shank 26 of the torsion spring 24 abuts against the concentric portion 19 of cam 18, without exerting any moment on equaliser 8. Since spring 15 concurrently pushes the first projecting part 13 of equaliser 8 with a small arm with respect to the oscillation pin 5, which is not sufficient to win the existing friction forces, no thrust action is applied to the hinge.

In the position of the hinge close to the closure, as evident in FIG. 2, spring 15 exerts a moment on equaliser 8 that pushes door 12 towards its closed position. Shank 26 of the torsion spring 24 starts sliding on portion 20 with increasing distance of cam 18, thus exerting a moment on equaliser 8 that opposes the moment exerted by the first elastic member 15, thus decreasing its effect.

In the closed position of the hinge, visible in FIG. 3, spring 15 still exerts a moment that keeps door 12 closed and arm 26 of the torsion spring 24 abuts against the initial portion of portion 22 of cam 18 just beyond edge 21, thus exerting a moment whose effect adds to that of the first elastic member 15.

In the embodiment according to FIG. 15, there is provided a screw 28 screwed into the back of the hinge arm 1, against whose lower portion abuts the fixed shank 25 of the torsion spring 24. By adjusting screw 28 it is therefore possible to adjust the pre-compression force and thus, the contrast force of spring 24.

1. Hinge for pieces of furniture with an arm (1) fixable to the body of the piece of furniture (2) connected to a portion of hinge (11) that oscillates through two equalisers (7, 8) housed on transversal pins (5, 6, 9, 10) of which one equaliser (8) in the portion of one of its oscillation axes (5) exhibits a projecting part (13) forming a lever arm, and with an elastic member that stresses the projecting part (13) of the equaliser (8) so as to cause a thrust in the closing direction on the oscillating hinge portion (11), characterised in that one of the equalisers is provided with a second projecting part (18) on which a second elastic member acts so as to exert a thrust that, for an oscillation portion close to the closed position of the oscillating hinge portion (11) contrasts the thrust exerted by the first elastic member.

2. Hinge according to claim 1, characterised in that the two projecting parts (13, 18) on which the two elastic members respectively act, are arranged on the same equaliser (8).

3. Hinge according to claim 1 or 2, characterised in that the second projecting part (18) consists of a cam obtained on the U-bent sides of the equaliser (8) that is closer to the body of the piece of furniture (2), comprising a first portion (19) that is concentric to the oscillation axis (5), which in the closing direction of the hinge is followed by a portion (20) at increasing distance up to an edge (21) beyond which the distance rapidly decreases.

4. Hinge according to claim 3, characterised in that just before the closed position of the hinge, the elastic contrast member abuts against the decreasing distance portion (22) just beyond the farthest edge (21) from the oscillation axis (5).

5. Hinge according to any one of claims from 1 to 4, characterised in that the second elastic contrast member consists of a torsion spring (24) housed on a transversal pin (23) in the hinge arm (1), with a fixed shank (25) abutting against the back of the hinge arm (1) and the other shank (26) to the cam (18) of the equaliser (8).

6. Hinge according to claim 5, characterised in that the torsion spring (24) has a symmetrical shape, with the fixed shank (25) consisting of two central shanks (25′, 25″) connected to one another by a slot (27) and with two sides shanks (26) that abut against the cams (18) of the equaliser (8).

7. Hinge according to any one of claims from 1 to 6, characterised in that the fixed shank (25) of the torsion spring (24) abuts against the lower portion of a screw (28) screwed in the back of the hinge arm (1).
The above as substantially described, illustrated and claimed and for the specified purposes.
